(19) United States
(12) Patent Application Publication
(10) Pub. No.: US 2010/0237293 A1
(43) Pub. Date: Sep. 23, 2010

(54) USE OF POLYAMIDE COMPOSITIONS FOR MAKING MOLDED ARTICLES HAVING IMPROVED ADHESION, MOLDED ARTICLES THEREOF AND METHODS FOR ADHERING SUCH MATERIALS

(75) Inventor: Olaf Norbert Kirchner, Genolier (CH)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/789,526

(22) Filed: May 28, 2010

Related U.S. Application Data
(62) Division of application No. 12/313,207, filed on Nov. 18, 2008.
(60) Provisional application No. 61/003,622, filed on Nov. 19, 2007.

(51) Int. Cl. H01B 1/20; B29C 41/00; G01P 3/00

(52) U.S. Cl. 252/500; 427/212; 73/504.01

(57) ABSTRACT

The present invention relates to encapsulated electrical/electronic devices and the use of polyamide compositions comprising at least one semi-aromatic polyamide and at least one aliphatic semi-aromatic polyamide, in particular, for encapsulating electrical/electronic devices.

### CROSS-REFERENCE TO RELATED APPLICATIONS

This application is a division of U.S. application Ser. No. 12/313,207, filed Nov. 18, 2008, which is a non-provisional of U.S. Application No. 61/003,622, filed Nov. 19, 2007.

### FIELD OF INVENTION

The present invention relates to the field of using polyamide compositions comprising at least one semi-aromatic polyamide and at least one aliphatic semi-aromatic polyamide, in particular, for encapsulating electrical/electronic devices.

### BACKGROUND OF THE INVENTION

Thermoplastic aliphatic polyamide compositions are desirable for use in many applications such as for example in automobiles, electrical/electronic parts and furniture because of their good physical properties and that they may be conveniently and flexibly molded into a variety of articles of varying degrees of complexity and intricacy. However, articles molded from polyamide 66, for example, exhibit dimensional variation upon moisture absorption and tend to deform, swell or crack when they are used for extended period at high temperature and when exposed to chemicals. Semi-aromatic polyamides combine excellent structural strength, toughness and dimensional stability at typical ambient conditions and in harsh environments. Such harsh environments can involve long or short term exposure to elevated temperature, high humidity and aggressive chemicals.

To overcome drawbacks of compositions comprising separately either aliphatic polyamides or semi-aromatic polyamides, polyamide blends comprising both kinds of polyamides have been developed to offer a balance of properties in terms of mechanical properties, processability and heat resistance.

U.S. Pat. No. 4,410,661 discloses a polyamide blend comprising semi-aromatic thermoplastic polyamides, aliphatic polyamides and toughening agents to produce molding articles said to have good mechanical properties, such as for example improved notched Izod values.

JP 06271766 and JP 06271769 disclose compositions comprising an aliphatic polyamide, a semi-aromatic polyamide and fibrous fillers. Shaped articles made from these compositions are said to be useful for making parts of electric and electronic appliances and cars and are said to show improved mechanical properties, heat resistivity and shaping processability.

WO 2004/092274 discloses a polyamide composition and an article that is blow molded. The blow molded articles made of compositions comprising a semi-aromatic polyamides, one or more aliphatic polyamides, an impact modifier and one or more stabilizers are said to exhibit excellent heat resistance, chemical resistance and dimensional stability.

WO 95/20630 discloses a polyamide composition comprising a semi-aromatic polyamide, at least one aliphatic polyamide to adjust the fluidity of the composition and an inorganic filler. Articles molded from such compositions are said to have good molding fluidity, heat and chemical resistance and dimensional stability.

WO 94/25530 discloses a polymeric composition comprising a first semi-aromatic polyamide, a second polyamide selected from aliphatic polyamide, semi-aromatic polyamide and mixtures thereof, and a mineral filler. Such polymeric compositions are said to be useful to manufacture product using melt processing techniques when resistance to high temperature and smooth glossy surface are required.

For making complicated moulded articles, it is often desired to “overmould” parts of one or more polymers. Overmoulding involves moulding or shaping a first polymer part, followed by moulding or shaping a second polymer part directly onto the surface of the first polymer part, which is in a solid state, to form a two-part article, wherein the two parts are adhered one to the other at least one interface. Adhesion is due to compatibility of the two polymers. Overmoulding can be used for packaging or encapsulation of objects such as sensors, electrical coils and electronic component of various types by polymer and is of particular interest in the automotive industry, where it is often desired to encapsulate devices to protect them from the surrounding environment. The polymer compositions used to encapsulate such devices are desired to have extremely good dimensional stability and retain their mechanical properties under adverse conditions so that the devices are protected from the operating conditions and thus have an increased lifetime. Examples of engineering plastics used as housings for electric/electronical devices are PBT (polybutylene terephthalate), polyamide 6, polyamide 6,6 and polyamide 6T. To make such encapsulated devices using overmoulding, a first polymer part is shaped or moulded, then the device is placed in a larger mould with the first polymer part, and a second polymer part is moulded on the top of the first polymer part, thus encapsulating the device. Unfortunately, polymer compositions that are used to encapsulate electrical/electronic devices show only poor adhesion when parts made of such compositions are moulded on each other or on another piece. This low adhesion of thermoplastic parts that are adhered together is highly unfavorable to the integrity of the devices that are encapsulated therein. The poor adhesion results in the formation of cracks on the interface of the molded pieces and on the surface of the final article so that the deterioration of the encapsulation upon use and time limits the useful lifetime of the devices encapsulated therein.

There is a need for a polyamide-based resin composition having improved adhesion when at least two moulded parts are adhered to each other.

### SUMMARY OF THE INVENTION

It has been surprisingly found that the above mentioned problems can be overcome by the use of a polyamide composition for making at least a moulded part of a moulded article comprising at least two moulded parts adhered to each other, wherein the polyamide composition comprises:
a) one or more semi-aromatic polyamide copolymers (A) containing repeat units derived from aromatic dicarboxylic acids and aliphatic diamines,
b) one or more fully aliphatic polyamide copolymers (B) selected from the group consisting of polyamides containing repeat units derived from aliphatic dicarboxylic acids and aliphatic diamines, polyamides containing repeat units derived from aliphatic aminocarboxylic acids, and polyamides derived from lactams.

In a second aspect, the invention provides a method for adhering at least one part made of the polyamide composition described above at one or more contact surfaces of at least one other part made of a polymeric composition, comprising a step of moulding the polyamide composition onto the surface of the at least one other part made of a polymeric composition or moulding the polymeric composition onto the surface of the at least one part made of the polyamide composition.

In a third aspect, the invention provides a moulded article comprising at least two parts adhered to each other, wherein at least one of the moulded parts is made of the polyamide composition described above.

### DETAILED DESCRIPTION OF THE DRAWING

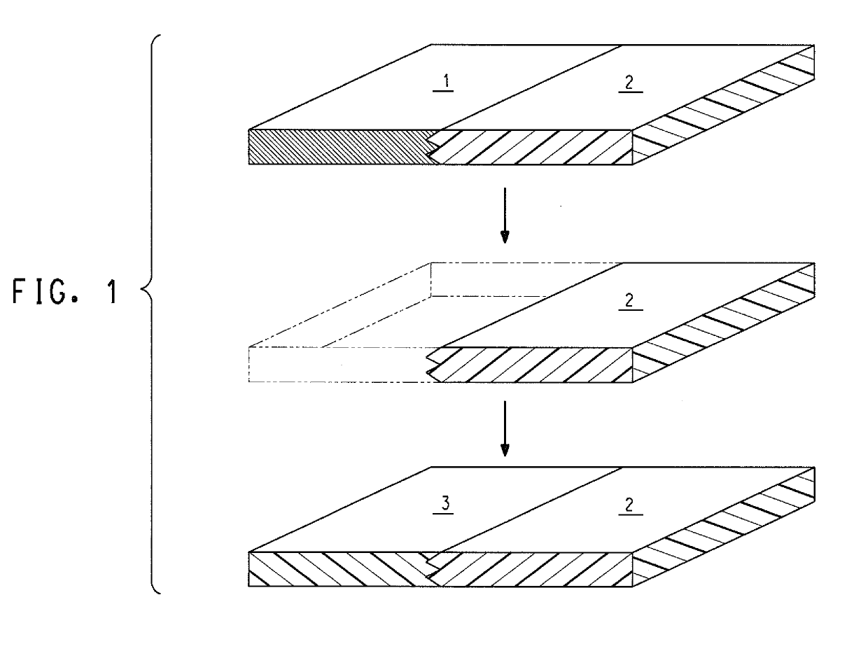

FIG. 1 is a schematic view of a moulded article comprising two parts adhered to each other. A designates a side view; B is a top view of the article.

### DETAILED DESCRIPTION OF THE INVENTION

Polyamides are condensation products of one or more dicarboxylic acids and one or more diamines, and/or one or more aminocarboxylic acids, and/or ring-opening polymerization products of one or more cyclic lactams. Suitable cyclic lactams are caprolactam and laurolactam.

The term “semi-aromatic” is related to the fact that the polyamide copolymer comprises aromatic carboxylic acid monomer(s) and aliphatic diamine monomer(s), in comparison with “fully aliphatic” polyamide which is related to aliphatic carboxylic acid monomer(s) and aliphatic diamine monomer(s).

The one or more semi-aromatic polyamide copolymers (A) comprised in the polyamide composition of the present invention are formed from one or more aromatic carboxylic acid components and one or more diamine components.

The one or more aromatic carboxylic acids can be terephthalic acid or mixtures of terephthalic acid and one or more other carboxylic acids, like isophthalic acid, phthalic acid, 2-methylterephthalic acid and naphthalenedicarboxylic, wherein the carboxylic acid component contains at least 55 mole-% of terephthalic acid (the mole-% being based on the carboxylic acid mixture). Preferably, the one or more aromatic carboxylic acids are selected from terephthalic acid, isophtalic acid and mixtures thereof and more preferably, the one or more carboxylic acids are mixtures of terephthalic acid and isophthalic acid, wherein the mixture contains at least 55 mole-% of terephthalic acid. More preferably, the one or more carboxylic acids is 100% terephthalic acid. Furthermore, the one or more carboxylic acids can be mixed with one or more aliphatic carboxylic acids, like adipic acid; pimelic acid; suberic acid; azelaic acid; sebacid acid and dodecanedioic acid, adipic acid being preferred. More preferably the mixture of terephthalic acid and adipic acid comprised in the one or more carboxylic acids mixtures of the one or more semi-aromatic polyamide (A) contains at least 55 mole-% of terephthalic acid.

The one or more semi-aromatic polyamide copolymers (A) according to the present invention comprises one or more diamines that can be chosen among diamines having four or more carbon atoms, including, but not limited to tetramethylene diamine, hexamethylene diamine, octamethylene diamine, decamethylene diamine, 2-methylpentamethylene diamine, 2-ethyltetramethylene diamine, 2-methyloctamethylenediamine; trimethylhexamethylenediamine and/or mixtures thereof. Preferably, the one or more diamines of the one or more semi-aromatic polyamide copolymer (A) according to the present invention are selected from hexamethylene diamine, 2-methyl pentamethylene diamine and mixtures thereof, and more preferably the one or more diamines of the one or more semi-aromatic polyamide copolymer (A) are selected from hexamethylene diamine and mixtures of hexamethylene diamine and 2-methyl pentamethylene diamine wherein the mixture contains at least 50 mole-% of hexamethylene diamine (the mole-% being based on the diamines mixture). Examples of semi-aromatic polyamide (A) useful in the polyamide composition of the present invention are commercially available under the trademark Zyter HTN from E. I. du Pont de Nemours and Company, Wilmington, Del.

The one or more fully aliphatic polyamide copolymers (B) comprised in the polyamide composition of the present invention are formed from aliphatic and alicyclic monomers such as diamines, dicarboxylic acids, lactams, aminocarboxylic acids, and their reactive equivalents. A suitable aminocarboxylic acid is 11-aminododecanoic acid. Suitable lactams are caprolactam and laurolactam. In the context of this invention, the term “fully aliphatic polyamide” also refers to copolymers derived from two or more such monomers and blends of two or more fully aliphatic polyamides. Linear, branched, and cyclic monomers may be used.

Carboxylic acid monomers comprised in the fully aliphatic polyamides are aliphatic carboxylic acids, such as for example adipic acid (C6), pimelic acid (C7), suberic acid (C8), azelaic acid (C9), sebacic acid (C10), dodecanedioic acid (C12) and tetradecanedioic acid (C14). Preferably, the aliphatic dicarboxylic acids of the one or more fully aliphatic polyamide copolymer (B) are selected from adipic acid and dodecanedioic acid. The one or more fully aliphatic polyamide copolymers (B) according to the present invention comprise an aliphatic diamine as previously described. Preferably, the one or more diamine monomers of the one or more fully aliphatic polyamide copolymer (B) according to the present invention are selected from tetramethylene diamine and hexamethylene diamine. Suitable examples fully aliphatic polyamides include polyamide 6; polyamide 6,6; polyamide 4,6; polyamide 6,10; polyamide 6,12; polyamide 6,14; polyamide 6,13; polyamide 6,15; polyamide 6,16; polyamide 11; polyamide 12; polyamide 9,10; polyamide 9,12; polyamide 9,13; polyamide 9,14; polyamide 9,15; polyamide 6,16; polyamide 9,36; polyamide 10,10; polyamide 10,12; polyamide 10,13; polyamide 10,14; polyamide 12,10; polyamide 12,12; polyamide 12,13; polyamide 12,14. Preferred examples of full aliphatic polyamide (B) useful in the polyamide composition of the present invention are poly(hexamethylene adipamide) (polyamide 66, PA66, also called nylon 66), poly(hexamethylene dodecanoamide) (polyamide 612, PA612, also called nylon 612) and are commercially available under the trademark Zytel® from E. I. du Pont de Nemours and Company, Wilmington, Del.

Preferably, the above described one or more semi-aromatic polyamide copolymers (A) and one or more one or more fully aliphatic polyamide copolymers (B) are used in a weight ration (A:B) from about 99:1 to about 5:95, more preferably from about 97:3 to about 50:50 and still more preferably from about 95:5 to about 65:35.

Optionally, the polyamide composition of the invention may include additives which are generally comprised in polyamide compositions.

The polyamide compositions optionally may further comprise one or more impact modifiers. Preferred impact modifiers include those typically used for polyamide compositions, including carboxyl-substituted polyolefins, ionomers and/or mixtures thereof.

Carboxyl-substituted polyolefins are polyolefins that have carboxylic moieties attached thereto, either on the polyolefin backbone itself or on side chains. By “carboxylic moieties” it is meant carboxylic groups such as one or more of dicarboxylic acids, diesters, dicarboxylic monoesters, acid anhydrides, and monocarboxylic acids and esters. Useful impact modifiers include dicarboxyl-substituted polyolefins, which are polyolefins that have dicarboxylic moieties attached thereto, either on the polyolefin backbone itself or on side chains. By “dicarboxylic moiety” it is meant dicarboxylic groups such as one or more of dicarboxylic acids, diesters, dicarboxylic monoesters, and acid anhydrides.

The impact modifier may be based on an ethylene/alpha-olefin polyolefin such as for example ethylene/octene. Diene monomers such as 1,4-butadiene; 1,4-hexadiene; or dicyclopentadiene may optionally be used in the preparation of the polyolefin. Preferred polyolefins include ethylene-propylene-diene (EPDM) and styrene-ethylene-butadiene-styrene (SEBS) polymers. More preferred polyolefins include ethylene-propylene-diene (EPDM), wherein the term “EPDM” terpolymer of ethylene, an alpha olefin having from three to ten carbon atoms, and a copolymerizable non-conjugated diene such as 5-ethylidene-2-norbornene, diclyclopentadiene, 1,4-hexadiene, and the like. As will be understood by those skilled in the art, the impact modifier may or may not have one or more carboxyl moieties attached thereto.

The carboxyl moiety may be introduced during the preparation of the polyolefin by copolymerizing with an unsaturated carboxyl-containing monomer. Preferred is a copolymer of ethylene and maleic anhydride monoethyl ester. The carboxyl moiety may also be introduced by grafting the polyolefin with an unsaturated compound containing a carboxyl moiety, such as an acid, ester, diacid, diester, acid ester, or anhydride. A preferred grafting agent is maleic anhydride. Blends of polyolefins, such as polyethylene, polypropylene, and EPDM polymers with polyolefins that have been grafted with an unsaturated compound containing a carboxyl moiety may be used as an impact modifier.

The impact modifier may be based on ionomers. By “ionomer”, it is meant a carboxyl group containing polymer that has been neutralized or partially neutralized with metal cations such as zinc, sodium, or lithium and the like. Examples of ionomers are described in U.S. Pat. Nos. 3,264,272 and 4,187,358. Examples of suitable carboxyl group containing polymers include, but are not limited to, ethylene/acrylic acid copolymers and ethylene/methacrylic acid copolymers. The carboxyl group containing polymers may also be derived from one or more additional monomers, such as, but not limited to, butyl acrylate. Zinc salts are preferred neutralizing agents. Ionomers are commercially available under the trademark Surlyn® from E.I. du Pont de Nemours and Co., Wilmington, Del. When present, the one or more impact modifiers comprise up to at or about 30 wt-%, or preferably from at or about 3 to at or about 25 wt-%, or more preferably from at or about 5 to at or about 20 wt-%, the weight percentage being based on the total weight of the polyamide composition.

The polyamide composition used in the present invention may further contain reinforcing agents such as glass fibers, glass flakes, carbon fibers, mica, wollastonite, calcined clay, kaolin, magnesium sulfate, magnesium silicate, barium sulphate, titanium dioxide, sodium aluminum carbonate, barium ferrite, and potassium titanate.

The polyamide composition used in the present invention may further contain ultraviolet light stabilizers such as carbon black, substituted resorcinols, salicylates, benzotriazoles, and benzophenones.

The polyamide composition used in the present invention may further contain antioxidants such as phosphate or phosphonite stabilizers, hindered phenol stabilizers, hindered amine stabilizers, aromatic amine stabilizers, thioesters, and phenolic based anti-oxidants that hinder thermally induced oxidation of polymers where high temperature applications are used. When present, the oxidative stabilizers comprise from at or about 0.1 to at or about 3 wt-%, or preferably from at or about 0.1 to at or about 1 wt-%, or more preferably from at or about 0.1 to at or about 0.7 wt-%, the weight percentage being based on the total weight of the polyamide composition.

The polyamide composition used in the present invention may further contain flame retardant agents such as metal oxides (wherein the metal may be aluminum, iron, titanium, manganese, magnesium, zirconium, zinc, molybdenum, cobalt, bismuth, chromium, tin, antimony, nickel, copper and tungsten), metal powders (wherein the metal may be aluminum, iron, titanium, manganese, zinc, molybdenum, cobalt, bismuth, chromium, tin, antimony, nickel, copper and tungsten), metal salts such as zinc borate, zinc metaborate, barium metaborate, zinc carbonate, magnesium carbonate, calcium carbonate and barium carbonate, halogenated organic compounds like decabromodiphenyl ether, halogenated polymer such as poly(bromostyrene) and brominated polystyrene, melamine pyrophosphate, melamine cyanurate, melamine polyphosphate, red phosphorus, and the like.

The polyamide composition used in the present invention may further include modifiers and other ingredients, including, without limitation, lubricants and mold release agents (including stearic acid, stearyl alcohol and stearamides, and the like), antistatic agents, coloring agents (including dyes, pigments, carbon black, and the like), nucleating agents (talc, calcium fluoride, salts of phosphoric acid), crystallization promoting agents and other processing aids known in the polymer compounding art. These additives may be present in the composition in amounts and in forms well known in the art.

The polyamide compositions according to the present invention are melt-mixed blends, wherein all of the polymeric components are well-dispersed within each other and all of the non-polymeric ingredients are well-dispersed in and bound by the polymer matrix, such that the blend forms a unified whole. Any melt-mixing method may be used to combine the polymeric components and non-polymeric ingredients of the present invention. For example, the polymeric components and non-polymeric ingredients may be added to a melt mixer, such as, for example, a single or twin-screw extruder, a blender, a kneader, Haake mixer, a Brabender mixer, a Banbury mixer or a roll mixer, either all at once through a single step addition, or in a stepwise fashion, and then melt-mixed. When adding the polymeric components and non-polymeric ingredients in a stepwise fashion, part of the polymeric components and/or non-polymeric ingredients are first added and melt-mixed with the remaining polymeric components and non-polymeric ingredients being subsequently added and further melt-mixed until a well-mixed composition is obtained.

In another aspect, the present invention relates to a moulded article comprising at least two parts adhered to each other, wherein at least one of the moulded parts is made of the polyamide composition described above. Preferably, the at least two parts are adhered together by overmoulding. By “overmoulding”, it is meant that a component is molded onto the surface of a part made of the same component or a part made of another component, which part is in a solid state. This process includes that one of the components is moulded in a mould already containing the other component, the latter having been manufactured beforehand by any suitable means, such as for example extrusion moulding, injection moulding, thermoform moulding, compression moulding or blow moulding, so that both parts are adhered to each other at least one interface. The moulded article according to the present invention comprises at least one of the at least two moulded parts is made of the polyamide composition previously described. Preferably, the moulded article according to the present invention comprises at least two of the at least two moulded parts is made of the polyamide composition previously described above.

The method according to the present invention for adhering at least one part made of the polyamide composition described above at one or more contact surfaces of at least one other part made of a polymeric composition can be either done by a) overmoulding the polyamide composition according to the present invention onto the surface of the at least one other part made of a polymeric composition; or b) overmoulding the polymeric composition onto the surface of the least one part made of the polyamide composition according to the present invention.

The polymeric composition used in the at least one other part may comprise any thermoplastic and preferably, it comprises the same polyamide composition used in the at least one part made of the polyamide composition of the invention.

In another aspect, the present invention relates to encapsulated devices that are packaged or surrounded with the polyamide composition of the invention. In the past decades, the demand for sensors (electrical/electronic and electrical-mechanical systems) for use in automotive, appliance and industrial applications has strongly increased. These sensors are used in such systems to measure variables such as speed, position, temperature, pressure or fluid level. With the aim of protecting sensors used in automotive applications from the environment, like moisture, dirt, high temperature or mechanical damage, the polyamide composition of the present invention can be overmoulded around the periphery of the article encapsulate it and protect it.

The process for encapsulating an electrical/electronic device according to the present invention may be done either by a method that comprises the steps of:
moulding the polyamide composition onto the surface of said at least one other part made of a polymeric composition wherein an electrical/electronic device is at least partially encapsulated within the at least one other part made of a polymeric composition, which consists of: overmoulding said at least one other part made of a polymeric composition, so as to at least partially encapsulate said electrical/electronic device;
   or may be done by a method that comprises the steps of:
moulding the polymeric composition onto the surface of said at least one part made of the polyamide composition wherein an electrical/electronic device is at least partially encapsulated within said at least one part made of the polyamide composition, which consists of: overmoulding said at least one part made of the polyamide composition, so as to at least partially encapsulate said electrical/electronic device.

With the aim of having the electrical/electronic device in a precise place inside the mould such as it does not move during the overmoulding step of the process, the process for encapsulating an electrical/electronic device according to the present invention comprises the steps of:
a) shaping a first part made of the polymeric composition;
b) opening the mould;
c) inserting the electrical/electronic device; and
d) overmoulding the electrical/electronic device with a molten polymeric composition.
   By “shaping”, it is meant any shaping technique, such as for example extrusion moulding, injection moulding, thermoform moulding, compression moulding or blow moulding.

In a preferred embodiment, the encapsulated article is a wheel speed sensor that electronically monitors the speed at which a wheel is rotating and converts it into electric signals to the electronic control unit (ECU).

Since the wheel speed sensor is installed near the wheel and is exposed to severe conditions, it is required that the polymeric composition that encapsulates such pieces fits many requirements. Among such requirements, one can mention good structural strength, toughness and dimensional stability at typical ambient conditions and in harsh environments involving exposure to high temperature, high humidity and aggressive chemicals like automotive fluids as well as high adhesion on itself. This enables the encapsulated sensor to have a long-term resistance to the external conditions as well to vibrations occurring when the vehicle is rolling, leading to an increase of the lifetime of the sensor.

The invention will be further described in the Examples below.

### EXAMPLES

The following materials were used for preparing the polyamide compositions according to the present invention and comparative examples.
Fully aliphatic polyamide copolymer I: polyamide 6 (PA6) commercially available from BASF under the trademarks Ultramid®.
Fully aliphatic polyamide copolymer II: polyamide copolymer made of adipic acid and 1,6-hexamethylenediamine, this polymer is called PA6,6 and is commercially available from E. I. du Pont de Nemours and Company under the trademarks Zytel®.
Fully aliphatic polyamide copolymer III: polyamide copolymer made of sebacic acid and 1,6-hexamethylenediamine, this polymer is called PA6,10.
Fully aliphatic polyamide copolymer IV: polyamide copolymer made of dodecanedioic acid and 1,6-hexamethylenediamine, this polymer is called PA6,12 and is commercially available from E. I. du Pont de Nemours and Company under the trademarks Zytel®.
Fully aliphatic polyamide copolymer V: polyamide copolymer made of sebacic acid and decamethylene diamine, this polymer is called PA10,10.
Fully aliphatic polyamide copolymer VI: polyamide 11 (PA11) commercially available from DSM under the trademarks Stanyl®,
Fully aliphatic polyamide copolymer VII: polyamide 12 (PA12) commercially available from Arkema under the trademarks Rilsan®.
Fully aliphatic polyamide copolymer VIII: polyamide copolymer made of adipic acid and tetramethylenediamine, this polymer is called PA4,6 and is commercially available from Arkema under the trademarks Rilsan®.
Semi-aromatic polyamide copolymer I: polyamide copolymer made of terephthalic acid and 1,6-hexamethylenediamine (HMD) and 2-methylpentamethylenediamine (MPMD) (HMD:MPMD=50:50). This semi-aromatic polyamide is commercially available from E. I. du Pont de Nemours and Company, Wilmington, Del. under the trademarks Zytel® HTN.
Semi-aromatic polyamide copolymer II: polyamide composition comprising 50 wt-% of carboxylic acid monomers which are terephthalic acid and adipic acid (terphatlic acid: acid:adipic acid=55:45) and 50 wt-% of a diamine monomer which is 1,6-hexamethylenediamine (HMD). This semi-aromatic polyamide is commercially available from E. I. du Pont de Nemours and Company, Wilmington, Del. under the trademarks Zytel® HTN.

The compositions of the Examples (abbreviated as “E” in the table) and Comparative Examples (abbreviated as “C” in the table) were prepared by melt-compounding the ingredients shown in Table 1 in a twin-screw extruder.

### Preparation of the Test Specimen by Overmoulding

Test specimens (called “finger joint”, see FIG. 1) having a thickness of 25 mm and teeth of 2 mm depth which comprised two moulded parts adhered to each other that were made of the polyamide composition according to the present invention and comparative ones were prepared according to the following procedure:

first, a steel insert (also called “steel stop”) was placed in a mould to occupy the space that would be in a later stage filled with the second desired polymer composition (FIG. 1, 1). Then, the first desired polymer composition was injected under conditions that were appropriate for the specific polymer compositions into the remaining empty space (FIG. 1, 2). The steel insert was removed from the mould, thus leaving the first moulding part and a cavity. The second part was then overmoulded into the cavity, on the surface of the first moulded part (FIG. 1, 3).

### Adhesion Strength of the Moulded Test Specimens

Adhesion strength was measured as a force that caused the part to separate at the joint or interface between the two moulded parts. The specimens were placed in a standard Instron machine designed for testing tensile properties. The parts were pulled under standard conditions (ISO 527) for the resins being tested and the force to break the part was recorded.

Results are given in Table 1.

TABLE 1
Polyamide compositions according to the present invention (E1 to E8) and comparative ones (C1 to C6).

| | C1 | C2 | C3 | C4 | C5 | C6 | E1 | E2 | E3 | E4 | E5 | E6 | E7 | E8 |
|---|---|---|---|---|---|---|---|---|---|---|---|---|---|---|
| Semi-aromatic PA I | | 63.45 | | 27.20 | 38.55 | 34.55 | 27.05 | 27.05 | 27.05 | 27.05 | 27.05 | 27.05 | 27.05 | 27.05 |
| Semi-aromatic PA II | | | 63.68 | 28.50 | 38.55 | 34.55 | 27.05 | 27.05 | 27.05 | 27.05 | 27.05 | 27.05 | 27.05 | 27.05 |
| Fully aliphatic PA I (PA6) | | | | | | | 15.00 | | | | | | | |
| Fully aliphatic PA II (PA6,6) | | | | | | | | 15.00 | | | | | | |
| Fully aliphatic PA III (PA6,10) | | | | | | | | | 15.00 | | | | | |
| Fully aliphatic PA IV (PA6,12) | 64.50 | | | | | | | | | 15.00 | | | | |
| Fully aliphatic PA V (PA10,10) | | | | | | | | | | | 15.00 | | | |
| Fully aliphatic PA VI (PA11) | | | | | | | | | | | | 15.00 | | |
| Fully aliphatic PA VII (PA12) | | | | | | | | | | | | | 15.00 | |
| Fully aliphatic PA VIII (PA4,6) | | | | | | | | | | | | | | 15.00 |
| glass fibre | 33.00 | 35.00 | 35.00 | 35.00 | 20.00 | 20.00 | 20.00 | 20.00 | 20.00 | 20.00 | 20.00 | 20.00 | 20.00 | 20.00 |
| maleic anhydride modified | | | | 2.90 | | 4.36 | 4.36 | 4.36 | 4.36 | 4.36 | 4.36 | 4.36 | 4.36 | 4.36 |
| ethylene propylene hydrocarbon | | | | | | | | | | | | | | |
| (TRX 301 from DuPont) | | | | | | | | | | | | | | |
| copolymer of ethylene and | | | | 3.59 | | 3.64 | 3.64 | 3.64 | 3.64 | 3.64 | 3.64 | 3.64 | 3.64 | 3.64 |
| octene-1 | | | | | | | | | | | | | | |
| (Engage ™ 8180 from Dow) | | | | | | | | | | | | | | |
| hydrated magnesium silicate | | 0.30 | | 0.46 | | | | | | | | | | |
| of median particle size 1.0 μm | | | | | | | | | | | | | | |
| (Talcron MP10-52 talc from | | | | | | | | | | | | | | |
| Specialty Minerals) | | | | | | | | | | | | | | |
| inorganic heat stabiliser | | 0.40 | 0.40 | 0.52 | | | | | | | | | | |
| organic heat stabiliser | | | | 0.20 | 0.95 | 0.95 | 0.95 | 0.95 | 0.95 | 0.95 | 0.95 | 0.95 | 0.95 | 0.95 |
| Wax | 0.10 | 0.25 | 0.25 | 0.33 | 0.25 | 0.25 | 0.25 | 0.25 | 0.25 | 0.25 | 0.25 | 0.25 | 0.25 | 0.25 |
| carbon black concentrate | 2.40 | 0.60 | 0.67 | 1.30 | 1.70 | 1.70 | 1.70 | 1.70 | 1.70 | 1.70 | 1.70 | 1.70 | 1.70 | 1.70 |
| adhesion strength (kN) | 2.31 | 1.84 | 0.10 | 2.07 | 1.55 | 1.95 | 4.16 | 3.56 | 4.04 | 3.93 | 3.41 | 3.61 | 3.07 | 4.09 |

As shown in Table 1, comparative examples comprising either only aliphatic polyamide (C1) or only semi-aromatic polyamide (C2-C6) showed poor adhesion with values between 0.10 kN to 2.31 kN. In contrast, the examples according to the present invention showed adhesion value ranging from 3.07 kN to 4.16 kN. For example, a mixture comprising two semi-aromatic polyamides and the fully aliphatic polyamide PA 6.12 (E4) led to a 1.7 fold increase of the adhesion strength as compared with the composition comprising only fully aliphatic polyamide PA 6.12 (C1).

1. A process for encapsulating an electrical/electronic device comprising the steps of:
moulding a polyamide composition onto the surface of at least one other part made of a polymeric composition wherein an electrical/electronic device is at least partially encapsulated within the at least one other part made of a polymeric composition, which consists of: overmoulding said at least one other part made of a polymeric composition, so as to at least partially encapsulate said electrical/electronic device;
wherein the polyamide composition comprises one or more semi-aromatic polyamide copolymers (A) containing repeat units derived from aromatic dicarboxylic acids and aliphatic diamines, and one or more fully aliphatic polyamide copolymers (B) selected from the group consisting of polyamides containing repeat units derived from aliphatic dicarboxylic acids and aliphatic diamines, polyamides containing repeat units derived from aliphatic aminocarboxylic acids, and polyamides derived from lactams.

2. A process for encapsulating an electrical/electronic device comprising the steps of: moulding a polymeric composition onto the surface of at least one other part made of a polyamide composition wherein an electrical/electronic device is at least partially encapsulated within the at least one other part made of a polyamide composition, which consists of:
overmoulding said at least one other part made of a polyamide composition, so as to at least partially encapsulate said electrical/electronic device;
wherein the polyamide composition comprises one or more semi-aromatic polyamide copolymers (A) containing repeat units derived from aromatic dicarboxylic acids and aliphatic diamines, and one or more fully aliphatic polyamide copolymers (B) selected from the group consisting of polyamides containing repeat units derived from aliphatic dicarboxylic acids and aliphatic diamines, polyamides containing repeat units derived from aliphatic aminocarboxylic acids, and polyamides derived from lactams.

3. A process for encapsulating an electrical/electronic device comprising the steps of:
a) shaping a first part made of a polymeric composition;
b) opening the mould;
c) inserting the electrical/electronic device;
d) overmoulding the electrical/electronic device with a molten polymeric composition;
wherein the polymeric composition is a polyamide composition comprising one or more semi-aromatic polyamide copolymers (A) containing repeat units derived from aromatic dicarboxylic acids and aliphatic diamines, and one or more fully aliphatic polyamide copolymers (B) selected from the group consisting of polyamides containing repeat units derived from aliphatic dicarboxylic acids and aliphatic diamines, polyamides containing repeat units derived from aliphatic aminocarboxylic acids, and polyamides derived from lactams.

4. An encapsulated electronic/electrical device manufactured from any one of claims 1-3.

5. The encapsulated electronic/electrical device of claim 4, wherein the electronic/electrical device is a wheel speed sensor.
